(19) United States
(12) Patent Application Publication
(10) Pub. No.: US 2010/0179833 A1
(43) Pub. Date: Jul. 15, 2010

(54) AUTOMATED COACHING

(76) Inventors: MICHAEL F. ROIZEN, Shaker Heights, OH (US); Mehmet C. Oz, Cliffside Park, NJ (US); Jeffrey D. Roizen, Philadelphia, PA (US)

Correspondence Address: TAROLLI, SUNDHEIM, COVELL & TUMMINO L.L.P., 1300 EAST NINTH STREET, SUITE 1700, CLEVELAND, OH, 44114, US

(21) Appl. No.: 12/649,661

(22) Filed: Dec. 30, 2009

Related U.S. Application Data
(60) Provisional application No. 61/144,001, filed on Jan. 12, 2009.

(51) Int. Cl. G06Q 50/00; G06Q 10/00; G06F 3/01

(52) U.S. Cl. 705/3; 705/2; 705/7; 705/9; 715/752; 707/802

(57) ABSTRACT

System and methods are disclosed that provide a coaching system that is programmed to process data entered automatically or manually for a given client and determine an indication of progress for the given client according to a coaching plan designed for the client. A response generator automatically generates a personalized response for the given client depending on the indication of progress for the given client, which response can be sent to the given client with or without first being reviewed by the client's coach.

### RELATED APPLICATION

This application claims the benefit of U.S. Provisional Patent Application No. 61/144,001, filed Jan. 12, 2009, and entitled AUTOMATED COACHING, which is incorporated herein by reference.

### TECHNICAL FIELD

The present invention relates generally to systems and methods for personalized yet automated or semi-automated coaching using rules to help a client reach one or more goals.

### BACKGROUND

In the general sense, coaching is a method of directing, instructing, nudging and training a person or a group of people with the end to achieve some objective, goal or develop a special skill. The particular interaction between the coach and the individual being coached depends on a mutual respect and trust-relationship between the coach and the individual being coached. An important facet for the individual being coached is the end goal and the manner in which the coach interacts with the person by providing motivation and advice to assist the individual along a devised strategy to complete a series of short term goals or action plans intended advance the individual toward one or more final goal. Due to their effectiveness, coaching paradigms are being employed as support systems in a variety of areas in addition to athletics, including but not limited to social, business and health contexts.

As one example, wellness coaching can be described as a structure, supportive partnership between the participant (e.g., a patient) and the coach that effectively motivates behavior changed to enhance the health or wellness of the individual toward the achievement of health-related goals. The health related goals can include disease reversal or otherwise improve the quality of life for the patient. Thus, wellness coaching can provide motivation, encouragement and health education in the form of individualized attention to the patient to help eliminate ambivalence towards the course of action or plan that is required to reach certain goals. In contrast to the traditional approach to patient education, which focuses on diagnosis and informing the patient of specific requirements, coaching also provides individualized attention that focuses on relevant issues and concerns unique to the individual through a series of interactions between the coach and patient. That is, not only does such coaching provide health education for the patient, but also provides motivation and encouragement to assist the individual patient in reaching his or her goals.

In addition to the context of wellness coaching, coaching can exist in various other contexts. Each type of coaching that can be implemented typically involves a relationship between a coach and a client and interaction between the two to assist the individual being coached along a plan for the individual to meet a number of one or more goals.

While the concept of coaching has existed for numerous years, it has experienced somewhat limited applications due to the inherent limitations of the coach. For instance, a given coach may have other responsibilities that require significant time commitments. Despite the technological advances, it can become considerably time consuming to reach out or respond personally to each person being coached on a regular basis. Thus, there is a need to facilitate coaching in a way that can help coaches provide individualized and motivational guidance while supporting an increased number of individuals.

### SUMMARY

This invention relates to systems and methods to provide for personalized yet automated or semi-automated coaching that can be utilized to help a client reach one or more goals. The coaching can be implemented based using best judgment or evidence based rules. The invention is applicable to various types of coaching including, but not limited to wellness coaching, business or financial coaching, professional coaching, and life coaching. The approach employs a rules-based system that evaluates progress information from client communications and, based upon a predetermined plan, a response can be generated efficiently that is both positive and motivational to the client. The response can also be personal in style from coach and for client.

One embodiment of the invention provides a coaching system that includes a tracking system programmed to receive client data indicative of at least one client condition relevant to a coaching plan designed for a given client. A rules system is programmed to process progress data, which is derived at least in part from the client data, relative to a rule set established for the given client and determine an indication of progress for the given client relative to the coaching plan. A response generator automatically generates a message for the given client, the message having content that varies depending on the indication of progress determined for the given client.

The rule set can be proposed by an expert or expert panel, based evidence from a practice or literature, and modified as agreed upon by the patient, or client, and coach (coaches), or as data changes. Alternatively or additionally, a more personalized message can be added partially or be provided entirely in place of the automated response, such as by intervention of the coach or an associate thereof via a coaching interface. For instance, the coach can be notified automatically of a particular situation associated with the client that may require additional personal attention and review. The notification can be triggered based upon the application of the rules or in response to identifying a freeform entry by the client, such as in the form of text, audio or video.

It will be understood and appreciated that the term coach as used herein can refer to an individual coach or a team of individuals that cooperate to help the individual client. Additionally, it will be appreciated that the coaching systems and methods are applicable to virtually any type of coaching paradigm including, but not limited to those mentioned herein. Moreover, while the coaching approach is described with respect to an individual being coached, such coaching is equally applicable to an individual family or other grouping of individuals (e.g., a business group or other team) that can benefit from coaching to achieve a common set of one or more goals.

### BRIEF DESCRIPTION OF THE DRAWINGS

FIG. 1 is an example of a system that can be utilized to perform automated coaching according to an aspect of the invention.

FIG. 2 is a flow diagram depicting an example method that can be utilized to generate a response according to an aspect of the invention.

FIG. 3 depicts an example of a block diagram of a plan generator that can be utilized to personalize a plan or strategy for an individual client according to an aspect of the invention.

FIG. 4 depicts an example of a system that can be utilized to generate an update template for an individual client according to an aspect of the invention.

FIG. 5 depicts a block diagram of a response system that can be utilized to process update messages and provide responses for an individual client according to an aspect of the invention.

FIG. 6 depicts an example of coaching system that can be implemented to perform automated coaching according to another aspect of the invention.

FIG. 7 depicts an example of a GUI that can be implemented as part of a tracking system for a wellness paradigm according to an aspect of the invention.

FIG. 8 depicts an example of a “My Healthy Habits” GUI that can be implemented as part of a tracking system for viewing and entering selected health information according to an aspect of the invention.

FIG. 9 depicts an example of a “My General Activities” GUI that can be implemented as part of a tracking system for viewing and entering activity information according to an aspect of the invention.

FIG. 10 depicts an example of a “My Food Search” GUI that can be implemented as part of a tracking system for viewing and entering consumption information according to an aspect of the invention.

FIG. 11 depicts an example of a “My Weight & Waist” GUI that can be implemented as part of a tracking system for viewing and entering user weight and waist measurement information according to an aspect of the invention.

FIG. 12 depicts an example of a “My Diet Plan” GUI that can be implemented as part of a tracking system for viewing and entering diet plan information according to an aspect of the invention.

FIG. 13 depicts an example of a computer environment that can be utilized to perform various aspects of the invention.

### DETAILED DESCRIPTION

The invention relates to systems and methods to provide for automated or semi-automated coaching. The approach shown and described herein provides for a rules-based approach that can be employed to simplify and extend coaching on a larger scale. In the health-related context, this approach can allow doctors, as well as nurses/nurse practitioners or other health professionals, to encourage and support larger numbers of patients and not feel overwhelmed by numerous progress reports received from patients (e.g., via email). For instance, it is contemplated that the systems and methods described herein can enable a healthcare professional to coach even 500-1000 patients daily. The approach helps ensure that all progress reports are reviewed and corresponding responses are generated. However, the approach can reduce the amount of personal review to certain identified progress reports, such as those determined to have individualized questions, those determined to have specific requests or concerns or otherwise may be identified for evaluation. The suggested coaching points or responses may be modified based on patient risk factors, patient mental status, patient situation, or disease entity or combinations, such as based on a predefined client profile or other information acquired for the patient. Additionally or alternatively, the suggested coaching points and responses can be generated based on outcomes of that patient and/or of other patients with one set of coaching styles and/or rules such as to optimize patient outcome and coaching success. As a result, the coach can service more individuals while improving the likelihood of success for each patient in the program.

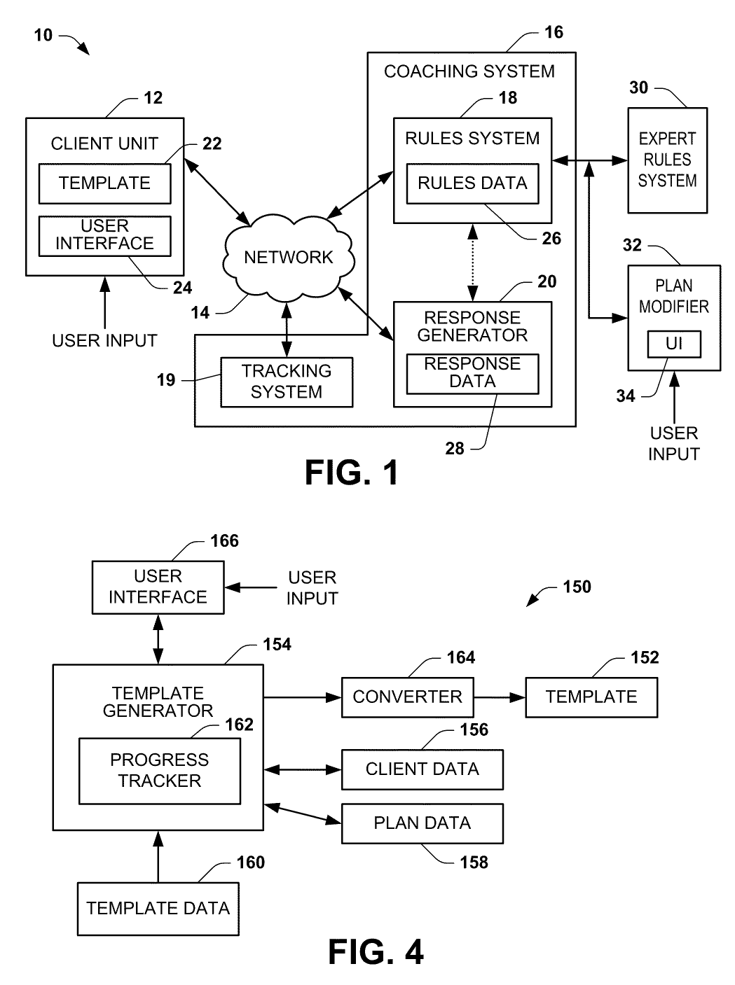

FIG. 1 depicts an example of a system 10 that can implement automated or semi-automated coaching according to an aspect of the invention. The system 10 includes a client unit 12 through which the client can interact with the coaching system 16. For instance, the client unit 12 is programmed to facilitate periodical or intermittent communication between the client and the client's coach. The client unit 12 can be implemented as any type of device capable of providing for communication of information reporting on the client's progress to the coach. The client unit 12 can also receive a response from the coach. By way of example, and not by way of limitation, the client unit 12 can be implemented as one or more device, such as may include a personal computer, a work station, a personal digital assistant (PDA), a cellular telephone or smart phone, an email ready appliance or an internet-ready appliance. It will be appreciated that some types of client devices may automatically send client information to the coaching system 16, while other types of client devices and interfaces may involve manual entry by the client. The coaching system 16 can be configured to receive and process information received from any combination of devices, which can vary depending on the goals and information being tracked for a given client.

The client unit 12 can communicate via one or more network 14. The network 14 can be implemented as including a local area network (LAN), wide area network (WAN, such as the internet), a public switch telephone network (PSTN), or any combination of one or more wired or wireless networks that can provide for communication of information between the client unit 12 and the coaching system 16.

The coaching system 16 can be programmed and/or configured to track or monitor the progress of one or any number of clients and to communicate with each such client. Such communication can be done by security installed system that is HIPAA compliant or non-HIPAA compliant as well as other security encoding schemes. The coaching system 16 employs a rules system 18 that is programmed to ascertain an indication of the client's progress with respect to a given plan or program. The rules system 18 can determine the client's progress by applying a set of rules associated with the client, such as can be designed to measure the client's progress in the given plan. The rules system 18 can be guided by an expert or expert system, such as described herein. The rules system 18 can modify an applicable set of rules according to the patient condition, based on patient outcomes. For instance, the rules system can employ a set of rules that can vary depending on a given set of patient circumstances (e.g., patient profile, patient condition, as well as other patient parameters). The set of rules can be selected, based on analysis of prior patient outcomes for the given patient or a group of similarly situated patients, to generate responses designed to achieve a desired patient outcome (e.g., designed to garner best patient outcome and lowest patient cost).

The coaching system 16 can include a tracking system 19 that is programmed to receive client information from each client and store the information in an associated database or other data structure. As mentioned above, the client information for a given client can be provided by one or more client and the tracking system can compile the various types of information into a format suitable for processing as client and progress data by the rules system 18. The client information can include, for example, vital statistics, client profile information, and progress for any number of one or more conditions or characteristics being monitored.

The coaching system 16 can also include a response generator 20 programmed to generate a corresponding response for the client based on the rules applied to the client and progress data for the client, and individualized to the client and/or to the coach (or coaches). The response generator can automatically generate a response in response to receiving progress data for a client. Alternatively, the response can be generated manually by the coach after receiving and reviewing a progress report. Additionally or alternatively, a response can be automatically generated, and be reviewed personally by a coach (or other authorized individual) and, if so desired, modified by the coach prior to being sent to the client (e.g., semi-automatically). The response can be positive and motivational to assist the individual to achieve one or more goals that are the subject of the relationship between the client and the coach. The response can be sent to the client unit 12 via the network 14.

It will be understood and appreciated that the system 10 is applicable to various different types of coaching paradigms including wellness coaching, personal coaching, business or financial coaching, sports coaching to name a few. For purposes of consistency many of the examples described herein relate to use of the coaching system 16 in the context of wellness coaching between a patient and a wellness coach, such as a doctor, nurse or other professional or a team of healthcare professionals. Thus, the systems and methods described herein can provide an effective and efficient means for organizing an automated or semi-automated response to patients in a disease reversal or wellness program such that the patient can achieve a higher quality of life through the motivational and positive responses and guidance provided through the coaching system 16. Those skilled in the art will appreciate that the automated and semi-automated approach described herein allows the coach to support and respond efficiently to a much larger number of patients on a regular basis without feeling overwhelmed.

As one example, the client unit 12 can employ a template 22 as a means for a client (e.g., a patient) to update or inform the coach about progress in the client's personalized program. The program can be designed for the client according to the condition of the client and the context in which the system 10 is being implemented. For instance, the program can correspond to a wellness program or disease reversal program that specifies a series of one or more action (or inaction) that are to be performed by the client over a period of time. As an example, a wellness or disease reversal program for a given patient-client may specify daily goals for the patient-client that are relevant to the patient's initial condition and/or disease category. The template 22 can vary according to the particular category of disease, patient's physical and/or mental condition, and a set of goals that have been suggested by an expert or expert panel and/or have been agreed upon by the coach and the patient. Thus, a unique template 22 can be created for eliciting information from a given client to track and monitor various categories of progress for the client in the pre-designed program.

The template 22 can be a static, common template that is utilized repeatedly by the client over the course of the program. Alternatively, the template 22 can also vary depending on where the client is within the scope of the program (e.g., is the client at the beginning, middle or near the end of the program cycle). For example, each response from the coaching system 16 to the client unit 12 can include an updated template or include some means (e.g., a hypertext link or URL to a webpage) for accessing an updated template via the client unit 12. As yet another example, the template can be generated by the tracking system 19 to provide a means for entering and updating client progress to the coaching system. To facilitate access to the template, the client unit 12 can include a user interface 24 through which the client can interact to specify the progress into the template 22, which can be provided back to the coaching system 16 in the form of the client and progress data. Those skilled in the art will understand and appreciate that the particular user interface 24 can vary according to the implementation of the client unit 12. The form of the template 22 can also vary according to the type of device on which the template is to be accessed by the client.

As a further example, the template 22 can be implemented as an email message in which the subject line includes particular information associated with the patient and the body of the email can include update information as of the client's progress, including whether certain goals were met or by specifying other information about the progress of the client in relation to the defined program. The template 22 may also allow freeform entry of text as well as provide a means for attaching audio, images or video data that can be provided to the coaching system 16.

Alternatively or additionally, the template 22 can be in the form of a web-based form (e.g., XML, HTML, plain text, or any other format). Such a template 22 can be accessed via a link that is provided to the client unit 12. Alternatively or additionally, the client can log on to a corresponding web server, such as can be associated with an electronic medical record or with the coaching system 16. The web-based template 22 can include a series of predefined questions specific to the client's plan through which the client can submit corresponding responses indicating his or her progress. The questions can be true/false type questions, multiple choice questions, as well as request numerical or text-based answers.

While the example of FIG. 1 depicts the client unit 12 communicating with the coaching system 16 via the network 14, it will be understood and appreciated that a client can enter responses in a template, which responses can be saved to a computer-readable medium, such as a disc or a flash drive. The computer-readable medium can be physically sent to the coaching system 16 for upload and responding. A client may also be able to transmit a progress report to the client's coach via other forms of electronic transmission, such as telephone or text message, or via facsimile. Thus, the system 10 is not limited by the manner that is employed to communicate progress information from the client unit 12 to the coaching system 16.

After submitting the template 22 or at least responses that have been entered into the template, the coaching system 16 can process the progress data that has been received. For example, a message can be received and the progress data for the client can be extracted and processed by the rules system 18. The rules system 18 includes rules data 26 that is programmed with a set of rules that can be applied to the progress data for determining if and to what extent the client's program goals have been met for a given time period. As an example, a wellness program for a patient can include a set of daily goals, such as can be established according to the patient's condition and the patient's disease (or multiple conditions or disease entities). Thus, the client and progress data provided via the template 22 can be compared relative to a set of defined benchmarks or goals for the patient as defined in the rules data 26. The rules system 18 can apply rules data 26 to analyze the progress data received for the current time period for the plan. Additionally, the rules system 18 can consider historical progress data previously submitted, such as to perform statistical analysis on the client's progress as well as to determine positive or negative trends.

The coaching system 16 also includes a response generator 20 that is programmed to generate a response depending upon the rules data that is applied to the progress data received for the client. The rules data 26 can be constructed from an expert or expert panel with or without information from evidence based literature. The rules system 18 further may modify or adjust rules based on patient condition (as reflected in progress data for a given patient), based on relative success of patient outcomes for a similar group or class of patients. The response can be generated and sent immediately after receiving the update report from the client. Alternatively, the sending of the response can be delayed (e.g., by a fixed or variable amount) to simulate time for the coach to receive, read and respond to each update report. The response generator 20 employs response data 28 that can be programmed with a plurality of responses that can be selected and provided in a message to provide for the client with a positive, motivational message to prod the client along a desired course of action (or inaction). The responses to any one person can be customized according to the patient profile or based on the condition of the patient. Additionally or alternatively, the response generator 20 can determine an appropriate response for a given patient based on the success of other responses sent to client's having like conditions (e.g., based on client profile data) and their outcomes for different types of responses. As an example, in a smoking cessation program for a given patient, if the patient has met all of the goals for a given day the response may state, “BRAVO, YOU HAVE MET YOUR GOALS—GREAT ON WALKING!”

It will be appreciated that the rules system 18 and response generator 20 can cooperate in formulating an appropriate response by selectively evaluating any number of different categories for which the client's progress is being evaluated. For instance, the rules system 18 may evaluate a plurality of different categories of behavior and objective criteria for a given time period, such as a day or a week. However for the given time period, such as the day or week, the rules system 18 may be programmed to determine that all goals have been met if a particular subset of core goals have been met or satisfied for a selected subset of the respective categories. For instance, if a selected subset of categories (e.g., categories 1, 2, 5 and 6 of 8 predefined categories) have been met for a given time period, a particular positive and motivational response can be formulated for the client regardless of the results for the goals in the other remaining categories (e.g., 3, 4, 7 and 8). However, in other situations, it may be necessary for a client to meet the entire set of goals to be considered to be successful. The particular requirements and for a given set of rules and responses can be customized according the client profile, including the client's initial condition and assessment by the coach and/or outcome of similar patients or patients with similar conditions to various responses), so that the responses encourage the client toward successful progress. The responses further can vary according to where the client is in a given plan.

As a further example, the rules system 18 can include or be associated with an expert rules system 30. The expert rules system 30 can be derived by an expert or a panel of experts having knowledge for the field or subject area in which the coaching system 16 is being implemented. For instance, the expert rules system 30 can establish a core set of rules based on evidence from practice (e.g., based on empirical evidence) or literature. The expert rules system 30 can be maintained separately from the rules system 18 that is implemented in the coaching system 16 or it may be integrated as part of the coaching system 16.

As a further example, the expert rules system 30 can support a plurality of the coaching systems 16, each of which can utilize the core set of rules provided by the expert rules system 30. For instance, each coach or coaching team can create a coaching system for its clients. However, it will be appreciated that the rules data 26 and response data 28 can be customized by each coach and further personalized for each client and/or coach. The expert or expert panel, which provide the cores set of rules via the expert rules system, can also update or modify the core set of rules, such as may be based on empirical evidence according to client outcomes or literature. As with the initial core set of rules established by the expert rules system 30, which is utilized by the coaching system 16, each coach may accept the updates or customize them according to personal preferences.

To facilitate modifying the plan, the system 10 can also include a plan modifier 32 that can be programmed to modify the rules data 26 and/or the response data 28 for the coaching system 16. The plan modifier 32 can be in communication with the coaching system 16 (directly or through the network 14). An authorized user, such as a coach or client, can have access to the plan modifier 32 via an associated user interface (e.g., a graphical user interface) 34. Such user can employ the user interface 34 to modify or request modifications to a given plan, which, if implemented, result in corresponding changes to the rules data 26 and/or the response data 28. For example, a coach may be authorized to change the rules data 26 and/or the response data 28 during implementation of a plan for a given client. A client, on the other hand, may employ the user interface 24 or 34 to request certain changes in the plan, which if agreed upon by the client and coach (or coaches), can be approved by the coach via his coaching interface to implement the changes. Additionally or alternatively, the plan modifier 32 may automatically implemented changes, such as in the form of updates, to the rules data 26 and/or the response data 28 for a given client plan in response to determining a given change in circumstances (e.g., based on client progress data) for the client or in response to changes in the core rules in the expert rules system 30. For instance, as described herein, the plan modifier 32 can adjust rules in a manner to garner best client outcomes based on an evaluation of which responses promote success for a similarly classified set of one or more clients.

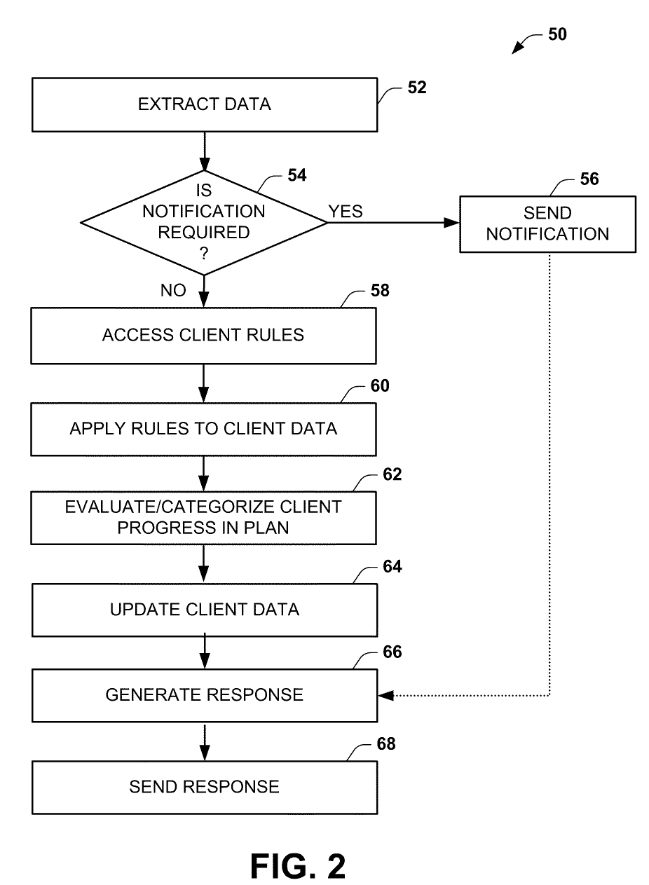

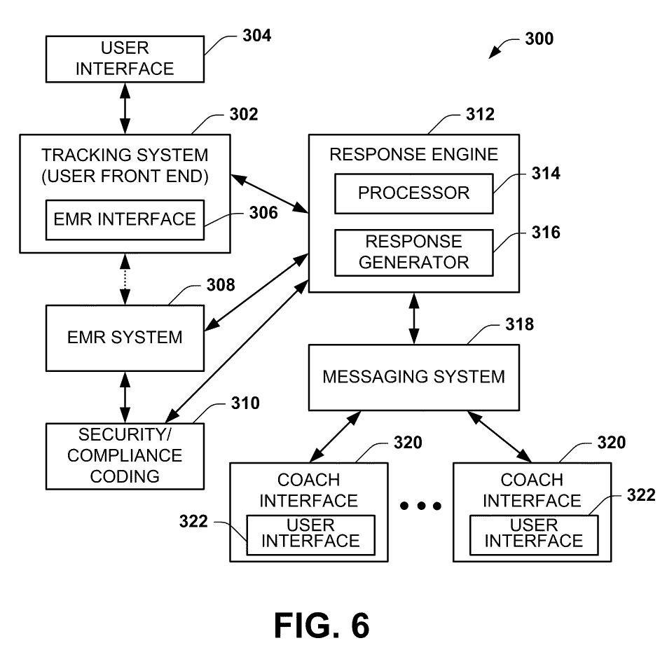

FIG. 2 is a flow diagram depicting an example of a method that can be utilized by the coaching system 16 (FIG. 1) for generating a response for a given client program. The method 50 can be implemented by a computer or computer system (see, e.g., FIG. 6) that is programmed to operate according to the method. In the description of the method of FIG. 2, reference may be made back to the system of FIG. 1 for additional context.

The method begins at 52 in which client progress data is extracted, aggregated and converted to a form that is usable by the coaching system 16. The progress data can be submitted in a variety of one or more forms, such as may vary depending on the device (or devices) used by the client to update his or her progress. For example, if the progress data is submitted via email, the email can be received by a messaging system and processed for automatic extraction of the progress data. As mentioned above the progress data can include specific responses to questions as well as free text form or other types of data. Various types of equipment and devices may be utilized to automatically send updates to corresponding progress data.

At 54, the progress data can be analyzed to determine whether the progress data indicates that notification is required. If notification is required (YES), the method proceeds to 56 in which a notification is sent to the coach. The notification can be sent via email, text message, instant messaging, or telephone call. The notification further can be sent to the patient's digital medical device or into a medical record or other mechanism that can be utilized to inform the patient, coach and/or other authorized person accordingly. As one example, if the client submits an email message that includes a free text entry or other types of predetermined data (e.g., audio or image data), or data is gathered from an automated wireless device (such as, but not limited to a blue tooth enabled pedometer, or glucometer, or blood pressure monitor), the entire email message or the free text or other type of data can be forwarded to the coach via email or other means of communication. Additionally, or alternatively, a template may include a selection box for requesting that the coach contact the client. In contrast, if no additional freeform text or other type of data is submitted by the client to the coaching system, no specific notification may be required.

In the determination at 54, if no notification is required (NO), the method proceeds from 54 to 58. At 58, an appropriate set of client rules are accessed. For example, the data extracted at 52 can include identifying information for the client, such as in the form as a client ID number, name or other identifying information that can be utilized to ascertain an appropriate set of rules for processing the progress data for a given client. For instance, the set of client rules can depend on client profile data stored for the client.

At 60, the appropriate rule set is applied to the progress data to ascertain whether the goals for the relevant time period have been met. The rules can be implemented, for example, as a set of Boolean logic rules and/or artificial intelligence. For instance, the rules system 18 can be implemented as an expert system, a neural network, a Bayesian network and the like that is programmed according to a knowledge base derived for the particular application context by a panel of experts, in which the goal-based program has been developed for the client. It is to be further appreciated that the rules data 26 can be static, or it can be dynamic and updated periodically by the coach or other individual having the appropriate level of access. For example, the rules data 26 can include an initial rule set that correspond to a default or best practices rule set, and the rule set can be expanded or modified by the coach or other authorized user or panel of experts for customization including client-specific customization for more individualized rules. The set of rules being applied can be interdependent upon each other, such that a single response in one category may alter the rules that are applied to a different category of progress based on the progress data that has been provided by the client.

After applying the rules to the extracted data at 60, the method proceeds to 62 to evaluate and/or categorize the results. The evaluation at 62 can correspond to an additional rule or analysis of results that may vary according to a particular time period in which the program currently exists. For instance, a certain subset of criteria may be evaluated to determine a level of success or quantified measure of progress for the client at a given stage of the program. The evaluation can be a scaled value or score (e.g., a scale of 1 to 10) or the categorization evaluation can enumerate grades or other types of scaled scores for a variety of different categories relevant to the client's particular program. At 64, the client progress data for the client can be updated. The updating can include storing the extracted progress data and the results of applying the rules, such as may be stored or appended to a client data record. It will be understood that certain rules and calculations can be applied automatically in response to client updates as part of the tracking system that is being implemented.

At 66, a corresponding response or set of responses can be generated at 66 based on the evaluation/categorization at 62, such as from response data 28. The response can be provided in a variety of different formats including text, audio, video or a combination thereof. At 68, the response is sent to the patient. The response can be sent in a variety of different manners, which may vary depending upon a selected manner in which the client has elected to access or receive the response. For example, the response can be sent as part of an email message that is sent via the network 14 to the client unit 12 at a predefined (one or more) email address for the client. Alternatively, the response generator 20 can post the response to a website that can be accessed by the client via the client unit 12. Those skilled in the art will understand and appreciate other forms of communication, such as instant messaging, text messaging via cellular telephone and the like that can be utilized to send the response from the coaching system to the client.

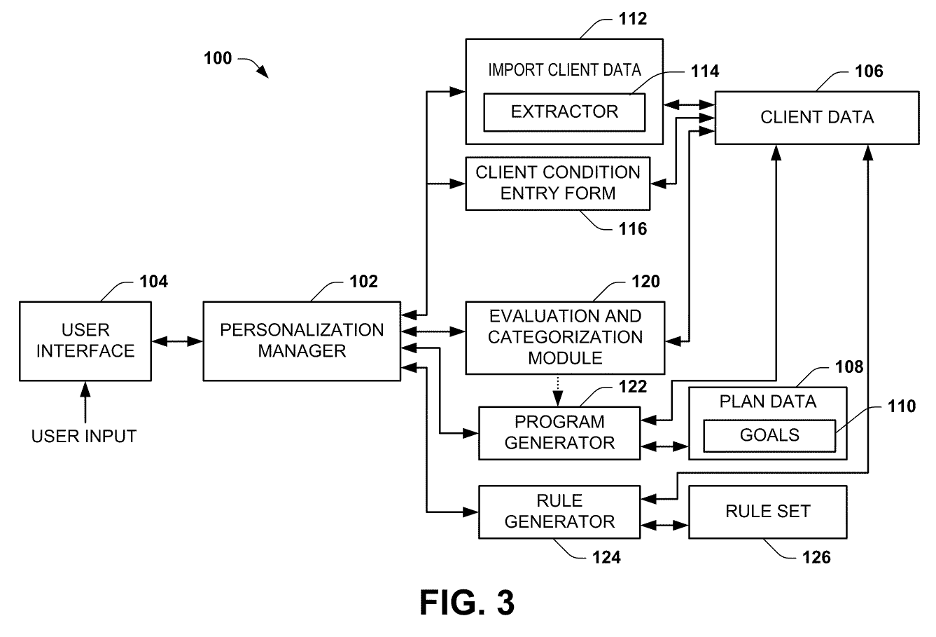

FIG. 3 depicts an example of a planning system 100 that can be utilized to personalize a plan or program for a client. The system 100 includes a personalization manager 102 that is programmed and/or configured to construct parameters for the program specifically for each client. The system 100 includes a user interface 104 through which the coach, an associate and/or the client can access the personalization manager 102 for defining client data 106 as well as establishing plan data 108 for a program that includes goals 110. The client data 106 can include client identifying information such as name, address and the like. The client data 106 can also include information that defines the condition of the client relevant to the goal or goals being performed by the system.

As an example, in the context of a wellness coaching program, the client data 106 can include information that characterizes a baseline health condition of a patient, such as including the patient's age, weight, blood pressure, temperature, as well as other indicators such as body fat data, waist size, marital status or any other information that can be utilized to characterize the condition of the client relevant to the patient's physical and/or mental health. The client data 106 can also include an indication of one or more disease or health condition category for the client, such as may have been assessed by a coach-doctor or other medical professional. Alternatively, the client category can be determined automatically as an objective function based on evaluation of some of the client data 106 or based on tests and/or questionnaires performed on the client-patient (e.g., by the coach or another professional). For instance, a client profile can be generated based on an assessment of client answers to a questionnaire that has been designed to provide an evaluation of a client's sensitivity, aggressiveness or other personality traits, which can be used to determine a type or tone of responses best suited for achieving a desired result to the coaching system.

The client data 106 can be entered manually and/or it can be imported from another source, such as from one or more external databases. For instance, the user interface 104 can access an import client data module 112 to upload or otherwise access a client record. As a further example, the import client data module 112 can include or otherwise implement an interface programmed to access an electronic medical record (EMR) for the client-patient. The import data module 112 can include an extractor 114 that in turn extracts relative patient data from the EMR and in turn populates a client data record 106 (wholly or in part) for use in the coaching system.

Additionally or alternatively, the system 100 can include a client condition entry form 116 that can present a plurality of fields to the coach and/or patient for use in entering at least portions of the client data 106. It would be understood and appreciated that the client condition entry form can vary according to the generalized goals that may be anticipated for the patient as well as further varying according to the context in which the coaching system is utilized. For example, a particular form 116 can be utilized for financial coaching to ascertain financial information for a given client including income, expenses, and investments as well as other information that can provide an indication of the financial condition for the individual. The client condition entry form 116 can be generated for each client by a tracking system such as described herein.

After the client data 106 has been created for a given client, an evaluation and categorization module 120 can be utilized to analyze the client data 106 such as to determine one or more client category. The evaluation and categorization module 120 can also be utilized to identify risks associated with the client's condition based on the analysis of the client data 106. The results of the evaluation via the module 120 can be utilized to set of goals, which may be identified automatically by the module 120, based upon the categorization and analysis by the coach through his/her professional experience and/or based on an agreement between the coach and client. The evaluation and categorization module 120 can be implemented as a fully automated method, a fully manual method or a combination of manual and automated (e.g., semi-automated) methods. For instance, the coach and client can interact with the module 120 via the user interface 104 to establish a set of specific goals 110 to be reached over the duration of program.

A program generator 122 can generate the plan data 108 that defines the client-specific program designed to help the client reach one or more goals 110, such as based on the information from the evaluation and categorization module 120. For example, the plan data 108 can specify goals 110 at defined periodic intervals, such as daily, weekly, monthly or the like. The plan data 108 further can be broken down into finer time increments, such as may vary depending upon the needs of the client and the demands of the coach. It will be appreciated that module 120 and the program generator 122 can be implemented as an iterative process that establishes an agreed upon plan for the client according to coach and client interactions via the user interface 104.

As a further example, for establishing a healthcare program to assist an individual with weight loss, the plan data 108 can include a series of dietary goals 110, such as but not limited to daily amount of saturated fat and amount of added sugars per meal, for each of a plurality of meals at specified meal time windows. The plan data 108 further can specify physical activity routine and desired weekly weight loss goals. Those skilled in the art will understand and appreciate that the temporal nature of the goals and program characteristics can vary depending upon the particular set of goals. For example, the system 100 can generate a predetermined plan that establishes a set of default goals, such as can be determined by the categorization based on the client data 106. This set of default goals can in turn be modified in response to user inputs provided via the user interface 104 to provide the resulting individualized plan data 108.

A rule generator 124 can construct a corresponding rule set 126 based on the plan data that has been finalized. The rule set 126 defines a set of rules that control automated or semi-automated analysis as well as generation of responses to program updates provided by the client, such as described herein. It is to be understood and appreciated that the coach may modify the rule set 126. Additionally or alternatively, the rule set 126 may be modified automatically in response to progress data sent by the client during the course of the program or based on other mechanisms described herein.

FIG. 4 depicts an example of a tracking system 150 or a portion of a tracking system that can be utilized for generating a template 152 and tracking client progress in a coaching system. The tracking system 150 includes a template generator 154 that is programmed to generate an individualized template 152 to facilitate reporting progress by the client. The template generator 154 can be programmed to generate the template 152 based upon client data 156 as well as based on plan data 158 for the client. A set of template data 160 can be provided for a given coaching context, such as may be predetermined to enable reporting of progress throughout the course of a given plan. The template generator 154 can, for example, compile selected portions of the template data based on the client data 156 and plan data 158 to produce the template 152.

The client data 156 and the plan data 158 may correspond to the client data and program data provided by the planning system 100 of FIG. 3. It is to be understood and appreciated that the client data 156 as well as the program data 158 may be updated during a client program, such as based on reporting by the client in performance of the actions/inactions defined by the plan. For instance, the client data 156 can be updated in response to progress data received by the tracking system 150, such as including action performed by the client, activity from which the client refrained, as well as a change in a client condition. The client data 158 can also include historical data as well as current data, which can be utilized provide an indication of progress (e.g., in the form of graph or other plot) for one or more criteria over a designated time period. As mentioned above, such current and historical data can include data entered (or logged) manually by the client into the tracking system 150 (e.g., weight, food choices, waist size, exercise activity) as well as data automatically entered based on client devices (e.g., a pedometer, glucose monitor, heart rate monitor or other device capable of monitoring and recording a condition of the client) that has been input into the coaching system. The historical client data can be integrated into the template 152, such as corresponding to any number of one or more conditions at defined time intervals to track trends or progression of selected client conditions and/or characteristics.

As a further example, the template generator 160 can also include a progress tracker 162 that is programmed to ascertain an indication of progress by the client relative to the program. As one example, the template 152 can be generated depending on the length of time that the client has been following the plan within expected variables. Alternatively or additionally, the progress tracker 162 can evaluate a portion of the client data 156 to ascertain additional information about the client's progress for any number of conditions according to the coaching plan. Based on the determined progress (or lack of progress), the template generator 154 can construct an appropriate template for the client. As an example, in a situation where the template 152 is customized and changes during the course of the coaching program, it may be necessary to reset the program back to an earlier time (e.g., back to an earlier phase), which may require generating a corresponding template for the client. For example, in a smoking cessation program, if the client has failed to reach one or more certain goals (e.g., by unpermitted smoking), it may be determined that the client needs to restart the program back to the first day in the plan. Thus, the template generator 154 might generate a template 152 corresponding to an earlier day (e.g., day 1) in the plan, as indicated by the results determined by the coaching system, instead of providing the template for the current stage in the plan.

The template generator 154 can provide the template 152 in a predetermined format associated with the system 150. A converter 164 may be employed convert the output from the template generator 154 into an appropriate format. For instance, the converter 164 can be programmed to convert a standard template to a different format, which can vary based upon a client device that has been defined for submitting progress reports and for receiving responses. The system 150 may also include a user interface 166 that can be utilized to manually define one or more queries or otherwise override information that may be sent to the client via the template 152.

It will further be understood and appreciated that, if desired, the template 152 can be provided to the client via one media (e.g., a website on the Internet) while responses are received by the client via a different type of media (e.g., email). Alternatively, a single media can be utilized for both providing the template and for receiving responses and progress information from the client. For example, the tracking system 150 can be implemented as website that generates the template as a series of web pages designed specifically for each given client. Each such web page can be utilized to receive client progress data (e.g., via user entry in defined fields) for a variety of conditions and characteristics as well as to provide an indication of the progress (e.g., graphical and/or textual information) for such client conditions over time.

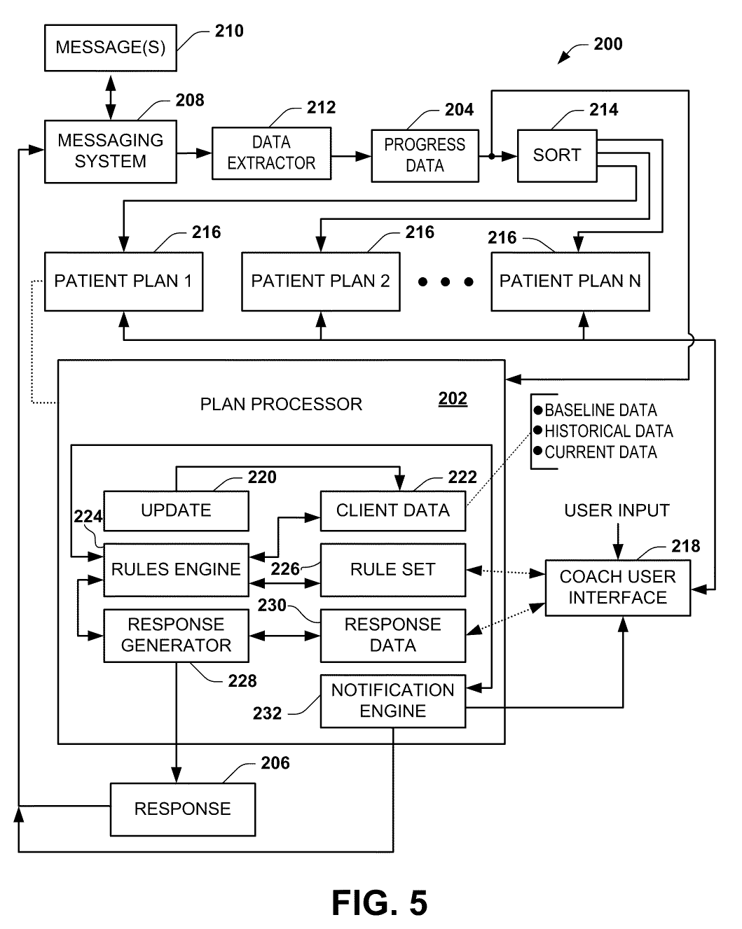

FIG. 5 depicts an example of a system that can be utilized for processing progress information and generating corresponding responses to clients according to one embodiment of the invention. The system 200 includes a plan processor 202 that is programmed to analyze client progress data 204 received from a client and, in turn, generate a corresponding response 206 that can be sent to the client. The method utilized to generate the response 206 can be fully automated such that no user intervention is required by the coach. Alternatively or additionally, some amount of user intervention may be required or desired, such as to enable a coach to approve, modify or otherwise personalize the response 206 that is sent to the client.

For example, the system 200 may include a programmable feature that can be set to require approval by a coach (or other authorized person) before a response 206 can be sent to the recipient client. The responses thus can be generated automatically and placed in a queue or other data structure that is accessible by the coach, such as via a coach user interface 218. As one example, the responses 206 can be automatically generated and sent to a predetermined email address and stored in inbox or other designated folder (e.g., a draft message folder of an email inbox) that is accessible by the coach. Each message may be labeled a draft or otherwise include an indicator (graphical or textual) designating the message as a draft response to a given client. In response to the coach approving the message, the message will be sent. The message can be the automated message or a modified version that has been personalized by the coach or other authorized individual.

The system 200 can employ a messaging system 208 which correspond to any system (e.g., an email system, an instant messaging system, or the like) programmed to send and receive messages 210, such as may be sent from or to a client as well as to and from a coach. In one example, the messages 210 can correspond to email messages sent via an email server as is known in the art. Alternatively, an incoming message from a client may be retrieved by the system 200 or otherwise posted and sent to the system from a web page or other data entry mechanism.

A data extractor 212 receives the message 210 from the messaging system and extracts corresponding progress data 204. The data extractor 212 can extract selected information from the message, which may vary depending upon the mechanism that is utilized to send the message to the system 200. The data extractor can parse the message 210 and identify data that identifies the client's progress, such as based on keyword parsing or by employing predefined terms in the message. For example, the extractor 212 can provide the progress data 204 to include an identification of the client, such as by name or other identification number and the like. The progress data 204 can also include information entered by the user according to a corresponding template (e.g., the template 152 generated as shown and described in FIG. 4). The progress data 204 may maintain the structure and format of the template or the progress data can include an extraction of the corresponding answers. As one example, the progress data can be provided as an XML document according to a predefined schema to facilitate extraction of relevant information. The extracted progress data can then be passed to the plan processor 202 for processing as described herein.

The system 200 can also include a sorting function 214 that is programmed to sort incoming messages provided by the messaging system 208 into different plans or categories, indicated at 216. There can be any number of N plans or categories 216, where N is a positive integer denoting the number of plans or categories. Continuing with the example of a healthcare coaching context, the plans or categories 216 can correspond to different diseases, patient conditions or to combinations of patient conditions and disease categories. Such information can be utilized to enable the coach to examine, via a coach user interface 218, messages associated with selected patient plans or categories 216. Additionally or alternatively, the patient plans or categories 216 can be arranged and organized by patient. For instance, each plan or category 216 may include a specific folder for each given client. In this way, a coach may refer back to and review prior responses such as to facilitate assessing progress for a given patient. Additional filter and sorting within a given plan or category 216 can be utilized, such as may be defined by the coach according to a set of coaching preferences.

With respect to the processing of progress data 204, the plan processor 202 can include an update component 220 that is programmed to update a client data record 222 based on the progress data 204. For example, the progress data 204 can include header or other identifying information for a given client that the update component 220 can utilize to append to corresponding fields in the client data record 222. The updated data can include a current progress for the client, such as entered via a client template that includes to the progress data. The client data record 222 can also include a collection of historical data for the client, such as based on previously received progress data as well as condition data for the client (e.g., including the client data 106 described with respect to FIG. 3). Alternatively, as described herein, in an embodiment where the client information is maintained directly by a tracking system, the tracking system can update the client data 222 in response information entered by the client, such as instead of via the messaging system 208.

The plan processor 202 can also include a rules engine 224 that is programmed to process the updated client data 222 based upon a rule set 226 for the given client. The rule set 226 can be chosen by a coach, which may be an individual or a panel of coaches, and be informed or guided by an expert or expert panel, which may be further informed by specific evidence-based data. As mentioned above, the rule set 226 can vary from client to client, and further may be modified dynamically in response to the progress data 204 received by the system 200. For example, the rule set 226 can be modified based on an analysis of progress for a given client, a similarly situated client, or based on a correlation of rules that have been determined to achieve desirable outcomes for other clients. Additionally, or alternatively, a coach (or other authorized individual) can employ the coach user interface 218 to modify the rules set 226 manually, such as based on a subjective and/or objective evaluation of the client progress as determined by the coach.

The rules engine 224 can apply the rule set 226 to at least a portion of the client data 222 (e.g., the progress data—current and/or historical progress data) for determining what goals have been met and/or have not been met by the client. Additionally, the rules engine 224 can determine whether an expected progress report or updated client data 222 has not been received from the client and take appropriate action, such as can include logging the missed report, sending a notification to the client and/or alerting the coach, such as via the messaging system 208. It is to be understood that the rules engine 224 can employ the rule set 226 to the current client data as well and analyze the historical data for use in determining an appropriate response 206. The application of the rule set 226 to the client data 222 can also create a corresponding results set indicative of the progress, which can be appended to the client data 222. The rules 226 can be a default set of rules or the rules can be customized by the coach, such as via the coach user interface 218.

A response generator 228 is programmed to generate the corresponding response 206 from response data 230 based upon the application of the rules 226 to at least a portion of the client data 222. As mentioned above, the results determined by the rules engine 224 can be based on application of the rule set 226 to the current progress data 204 or to the aggregate current and historical progress data contained in the client data record 222.

The response data 230 can include a set of potential responses that are considered to be appropriate depending upon what type of progress information may be provided with the progress data. That is, an appropriate set of one or more responses will be generated based on the application of the rules 226 to the client data. It is to be understood that the response data 230 can be a default set of responses according to the coaching context. The response data 230 can also be modified or customized by the coach, such as via the coach user interface 218, such as to reflect the personality and lexicon of the coach. Additionally or alternatively, the set of responses in the response data can be automatically or manually modified according to expert or other best practices, such as according to outcomes and results of coaching programs for other clients. Each response 206 can be sent to the intended recipient client via the messaging system 208, which can include posting for review via a web site, transmission via email or other type of messaging or communication. The communication can also be HIPPA compliant or non-HIPPA compliant and/or can employ encryption or other types of encoding schemes for sending the client message 210.

The system 200 may also include a notification engine 232 that is programmed to notify the coach in response to detecting certain predefined conditions. For example, if the progress data 204 indicates an occurrence of an event that is outside expected client conditions, the rules engine 224 can set a notification flag condition, thereby causing the notification engine 232 to issue a corresponding notice to the coach. The notification engine 232 can send the notice to the coach via the coach user interface 218 directly. Alternatively or additionally, the notification engine 232 can send a message to the coach via the messaging system 208, such as in the form of an email message, a text message, voice message, or the like. In addition to notifying the coach in certain circumstances, other third parties can be notified as may vary depending on the coaching paradigm being implemented by the system 200. One or more recipient of the notification can be set by the coach, such as via the user interface 218.

As another example, FIG. 6 depicts an example of a coaching system 300 that can be implemented in a variety of coaching contexts such as described herein. In the example of FIG. 6, the coaching system 300 includes a tracking system (or user front-end) 302 that operates similar to the template shown and described herein, as it provides a means for entering and managing client and progress data. The tracking system 304 is programmed to track progress of a client user according to the purpose for which the client (or group of clients) is being coached. Each client can interact with the tracking system 302 through a user interface 304, such as for entering the pertinent information relating to the individual's condition and circumstances for which the coaching is being implemented.

By way of example, the user interface 304 can be implemented as one or more webpage (e.g., including HTML or XML pages) that present any number of fields into which an individual can enter corresponding client and progress data. The user interface can also provide information to the client about progress in the program for any number of one or more conditions or characteristics that are related to the coaching program. The user interface 304 can be rendered as a web page on browser running on a user computer device that is remotely located relative to a server computer on which the tracking system 302 is implemented. Additionally or alternatively, the user interface 304 can be implemented as one or more device that is configured to automatically measure and transmit information to the tracking system 302 (e.g., continuously or a designated times). For instance, a pedometer or other health-based appliance can be utilized to monitor a condition such as a number of steps, heart rate, respiration and the like and transmit the detected information to the tracking system automatically via a corresponding communication link, which may be wired or wireless. A user may manually activate or otherwise utilize the user interface device at a desired time of day to track information that can be transmitted in response to the testing process and thereby send corresponding results to the tracking system 302. Additionally or alternatively, a user can input the results of one or more test into appropriate fields of a template via the user interface 304. Thus, the tracking system 302 can utilize a variety of data input mechanisms as user interfaces to receive or retrieve information about a client condition. The particular type or types of devices will vary according to a client's condition and the information that is to be utilized by the coaching system for tracking and determining a progress of each client. As explained herein, the extent of the information and the frequency that such information is entered into the tracking system 302 can vary according to the type of condition or conditions being coached.

As a further example, in the context of health or wellness coaching, the tracking system 302 can also include an electronic medical record (EMR) interface 306 that can be utilized to retrieve and/or send information to an associated EMR system 308. Thus, for the context of the healthcare or wellness coaching, the tracking system 302 can combine information entered by a user via the user interface 304 and information including health information that may be stored as part of the EMR system 308. The EMR system 308 can further utilize the security/compliance coding module 310 that can ensure that information transmitted between the EMR system 308 and the tracking system 302 is HIPPA compliant. For instance, the information can be coded such that it is not determinable as to the name or other identifying information for the user is coded in an appropriate manner.

The coaching system 300 also includes a response engine 312. The response engine 312 is programmed to monitor information received for each of one or more users via the tracking system 302 and in turn generate an appropriate response or responses, such as described herein. The response engine 312 can include a response processor 314 that is a rule based system that parses the information provided by the tracking system 302 to determine a condition or characteristic for the client relevant to the coaching program. The processer 314 can include an evaluation of the client's progress in one or more criteria for a given time period, such as a day, a week or otherwise may be appropriate or a combination of different time periods. The processor 314 can be programmed to parse client and progress data from the tracking system. For instance, the processor 314 can employ a keyword search engine programmed to locate numbers or predefined keywords that can be compared relative to the personalized plan (stored as plan data) for the client.

The response engine 312 also includes a response generator 316 that is programmed to generate a response based on the analyzing the client and progress data provided by the tracking system 302. For example, the response generator 316 can generate a draft response automatically based on applying the applicable set of rules to the client and progress data. The draft response can be selected by the response generator 316 from a set of preprogrammed responses. For instance, there can be a number of different preprogrammed responses applicable for each given result of the rules. As described herein, each response can be selected from a set of predetermined responses customized for a given coach or responses can be selected from a set of default responses stored as response data. For a given result (based on application of the rules), an appropriate response can be randomly (or pseudorandomly) selected from the set of applicable responses to seem as if the coach is drafting a unique response each time. Alternatively, the responses can be selected in a predefined, non-repeating order to reduce the likelihood of the client receiving the same responses repeatedly.

The response engine 312 can utilize a messaging system 318, such as an email system (e.g., Exchange Server from Microsoft Corporation in Redmond, Wash.), to send the draft response to the appropriate coach interface 320. Alternatively or additionally, the draft response can be sent to another authorized individual working under the direction the respective coach, who can review the draft response to ensure that the response is appropriate under the circumstances. The individual can be authorized to send responses to clients, such as in situations when no free-form entry of information has been provided by the user or the response does not otherwise require an increased level of scrutiny by the coach. Alternatively, the draft response can be sent directly to the coach and labeled as such or otherwise highlighted or including other identifying features (e.g., color coding scheme, graphical indicia adjacent the message) rendered in the coach interface 320.

As an example, the coach interface 320 can include an email system that includes a mailbox or folder for receiving messages from the messaging system 318 as generated by the response engine. Each coach interface 320 can also include or otherwise utilize a user interface 322 that implements tools or methods that provide for additional level of customization of responses as well as for sending the messages after it has been appropriately reviewed and approved for the intended client. The processor 314 and response generator 316 further can be programmed to evaluate user progress over time and correlate the progress to responses that have been generated and determine a set of responses expected to have improved results relative to other types of responses. This can develop a set of the best practice responses that can be selectively generated by the response generator for a given set of conditions.

Additionally or alternatively, the tracking system 302 can be utilized to develop a personality profile for each user that can be indicative of an individual's sensitivity, aggressively or other personality traits or characteristics or psychological profile that can be used to determine a type or tone of responses best suited for achieving a desired result to the coaching system. As an example, one individual may be depressed about a condition or otherwise experiencing psychological issues (e.g., depression or the like) such that a softer, gentler tone can be automatically implemented in the responses that are being generated and sent to the respective coach interfaces 320. By way of contrast, another individual may have an aggressive personality or have a somewhat defiant attitude that requires a more forceful and abrupt type of encouragement to help them achieve their goals. The client profiles thus can be utilized to track and determine which types of responses achieve the best type of success for different categories of clients and the individual's condition. Statistical analysis can be utilized to classify or categorize individuals according to a variety of characteristics including the individual's condition, the goals associated with the personalized plan for each individual, psychological profile and the like that can be aggregated together to determine a set of target responses that can be utilized for each given classification of clients. Thus, by categorizing responses (e.g., according to their aggressiveness or gentleness), appropriate responses can be automatically selected for a given client not only according to the client's progress, but also based on client profile information stored as part of the client data for each client. As the client's condition changes, the client profile can be updated accordingly, such that a different category of response can be utilized.

The response generator 316 can also provide graphical information back to the user as part of the response. For example, the response generator 316 can provide a graphical representation of an individual's progress in certain situations where it is deemed helpful to encourage the individual towards achieving a desired goal. The graphical information can be embedded in a response, such as an in an email message (e.g., as HTML or JPEG image). Alternatively or additionally, a link (e.g., URL) to suitable graphical information can be embedded in the email and automatically loaded on the individual's browser or email program. As another alternative, a URL can be provided in the message that can be activated by the user to activate a browser or other user interface capable of accessing and displaying the resource as a corresponding graphical representation that has been uniquely generated for the individual. The graphical representation can, for example, be a graph demonstrating an individual's progress for a given condition or set of conditions. Additionally or alternatively the image can be a digital photograph or image of something pleasant and soothing or otherwise considered rewarding to the individual. The response generator 316 can also provide a short video, audio, or audio and video file that can provide encouragement to the user (e.g., a motivational message from the coach). Those skilled in the art will understand and appreciate various fanciful images and documents that can be provided to the client, which can vary depending upon the relationship between the coach and the client as well as the individual preferences of the coach.

The response engine 312 can also utilize the security/compliance coding module 310 for use in generating the responses. For example, prior to a response being sent from the response engine 312 via the messaging system 318, the response can be routed to the security/compliance coding module 310 to remove patient identifying information as well as other information, such as to render the message HIPPA compliant.

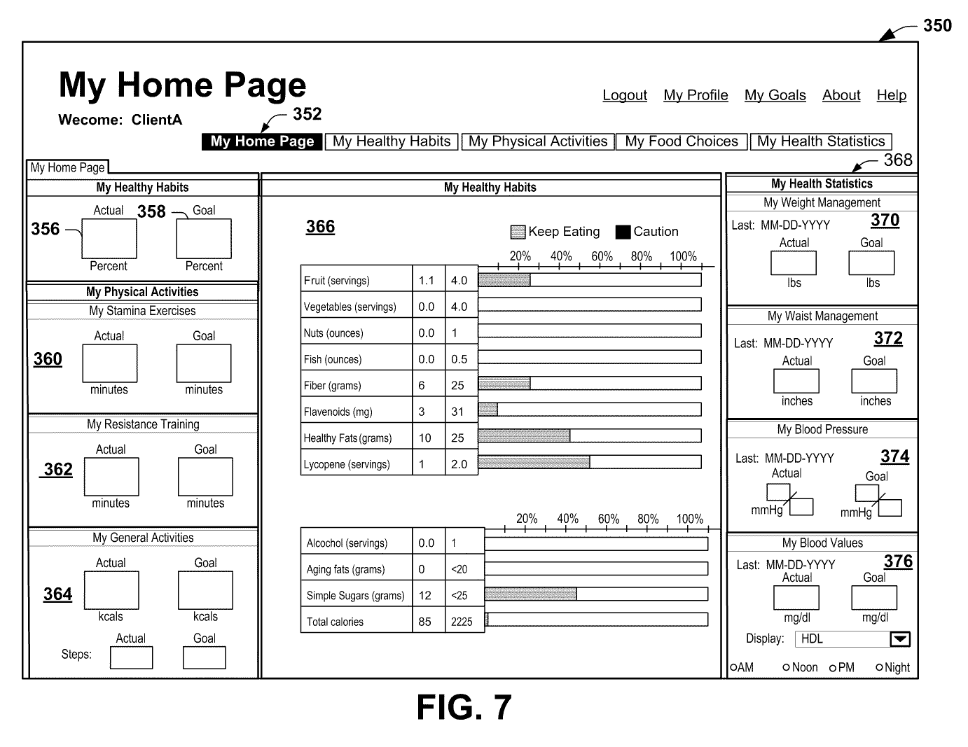

FIGS. 7-12 depict examples of graphical users interfaces (GUIs) that can be utilized as part of the user interface 304 implemented in the tracking system 302, such as shown and described herein. By way of example, the user interfaces of FIGS. 7-12 are depicted in the context of a wellness or lifestyle coaching system. It will be understood and appreciated that, as described herein, the coaching system of FIG. 6 and other figures are applicable to other types of coaching. The pages can be accessed by an authorized user, such as a client via a secure login script (e.g., entering a user name and password) and which can utilize security encoding.

Turning to FIG. 7, a GUI 350 for a client's home page is shown. The GUI can include a series of buttons, fields or other user-activatable elements that can be used to view and manage information for the respective client. In the example of FIG. 7, the GUI 350 includes a plurality of buttons 352 for accessing different web pages that can be utilized for entering information, displaying information or the like related to different aspects of the wellness coaching program. For instance, the buttons 352 include a “My Home Page” button, a “My Healthy Habits” button”, “My Physical Activities” button, “My Food Choices” button and a “My Health Statistics” button. The buttons 352 can vary according to the coach and the particular goals for each respective patient and the purpose of the coaching program.

In the “My Home Page” GUI 350, a general overview can be provided for the respective client, such as can include a selected subset of the information that is available via the other buttons 352. The information that is displayed can be correspond to a specified time period, such as a day, a week, a month or other period having a set of predefined goals that have been agreed upon between the client and the coach. Progress information can be represented in the GUI 350, such as provided in different user interface elements. For example, a GUI element 358 can provide an actual percent of healthy habits that have been achieved relative to a defined goal. Various physical activities can be identified in other GUI elements, including my stamina exercises element 360, a my resistance training GUI element 362, and a GUI element entitled my general activities 354. Each of these GUI elements can present to the client an actual number or other indication of progress associated with each respective activity relative to a goal that has been set as part of the coaching program.

Another portion of the GUI 350 includes a graphical display for the healthy habits broken down according to particular food types, indicated at 366, such as shown therein. Thus, in my healthy habits window 366, a graphical display can demonstrate an individual client's progress in relation to eating a predefined amount or a given healthy food group based upon information that has been entered by the client. Additionally, as an individual approaches consuming a maximum amount of a given food different colors or other identifiers can be utilized to alert the individual to use caution and avoid exceeding the predefined amount or limit for a given food category. This condition might also cause a response engine to automatically generate and send a message to the client on the same topic.

Also depicted in the GUI 350 is a health statistics GUI section 368, which displays health information or statistics for a variety of conditions or characteristics of the client. In the example of FIG. 7 these include My Weight Management GUI element 370, a My Waist Management GUI element 372, a My Blood Pressure GUI element 374 and a My Blood Values GUI element 376. Each of these GUI elements 370-376 can display information associated with the current value or otherwise provide an indication of progress for a given condition or characteristics relative to a corresponding goal.

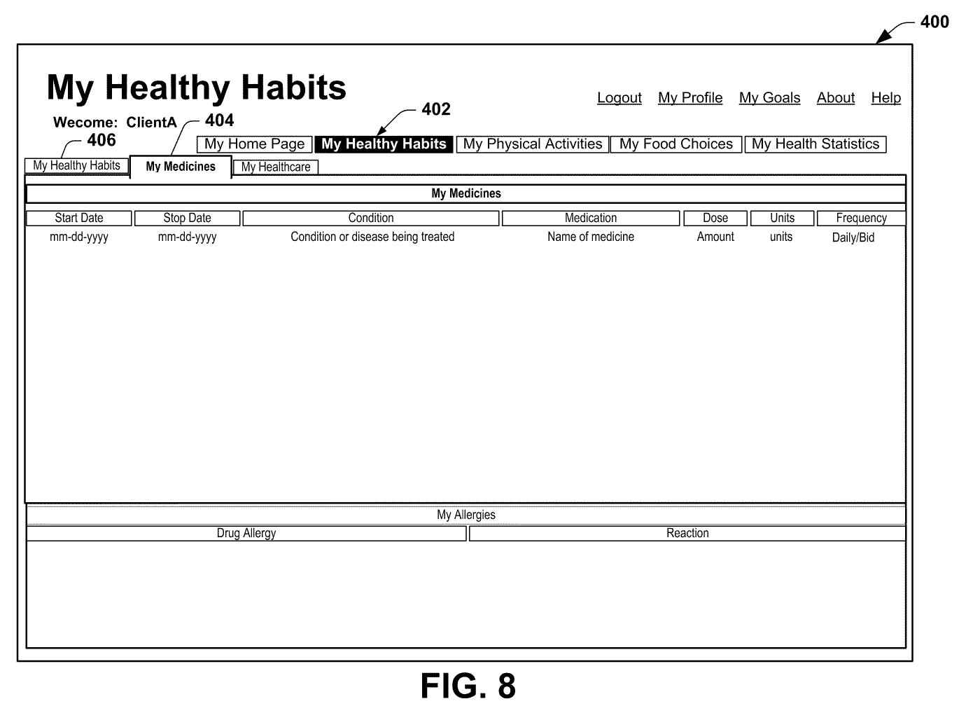

FIG. 8 demonstrates another GUI 400 that can be utilized to display and input information associated with an individual's health and medical conditions, such as can be accessed by selecting a My Healthy Habits user interface element 402. There can be any number of additional sub-pages accessible via the My Healthy Habits user interface element 402. In the example of FIG. 8, a My Medicines GUI element tab 404 has been selected in which an individual can identify current medication that an individual is taking. Drug allergies for the client can also be entered into the GUI 400. Other related pages can be accessed via corresponding tabs associated with the My Healthy Habits GUI 400 include a My Healthy Habits GUI element 406, which can include fields or other user input mechanism to list healthy habits, such as regular exercise routines, flossing or other conditions that can be deemed healthy lifestyle choices for an individual. A My Healthcare GUI element tab 408 can also be selected from the My Healthy Habits page to identify information associated with an individual's current health condition and types of treatment that may have been sought in the past or currently being received by the client.

Each of these tabs 402, 404 and 406 thus can be accessed to provide additional information about the individual's healthy habits and health condition, in general, which can be utilized by the coach to discern a more thorough understanding of the individual's needs and conditions. Additionally, information for one or more of the My Medicines and the My Healthcare GUI elements can be populated based on information obtained from the client's EMR, such as described herein. The tracking system can further track progress of such information and provide corresponding information to the response engine so that the automated messages can take into account an individual's healthy habits.

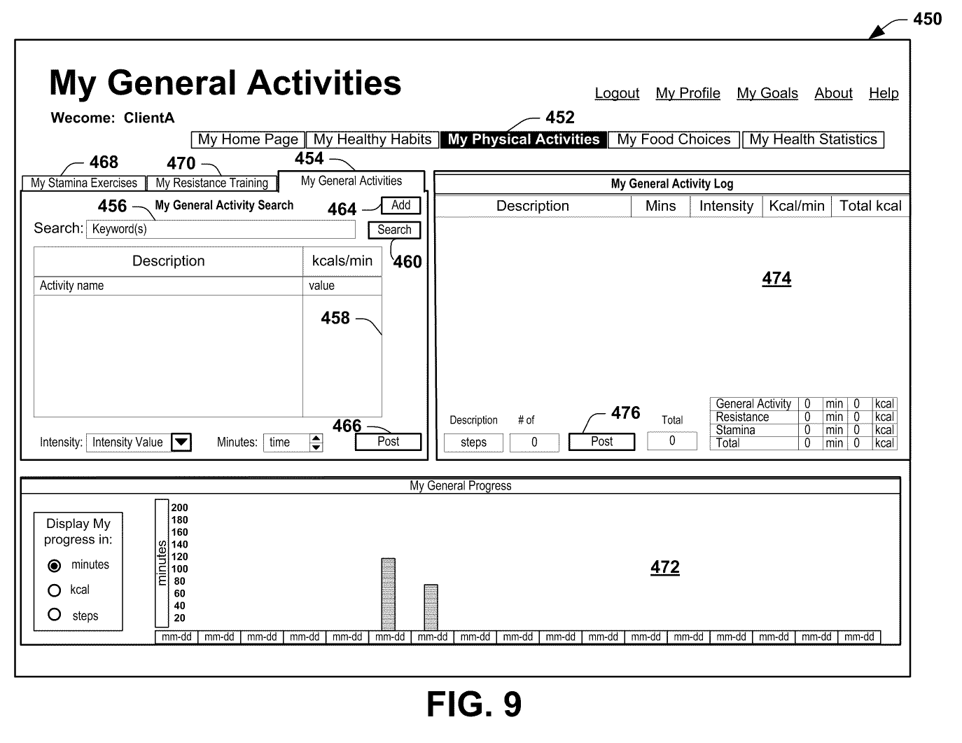

FIG. 9 depicts an example GUI 450 for physical activities, which can be accessed via a “My Physical Activities” user interface element 452. The My Physical Activities GUI 450 can include a plurality of different types of activities that can be entered into the system and, in turn, tracked in response to a user entering the amount of time or quantity of an activity that is performed by a client. For example, a My General Activities user interface element tab 454 can be accessed for inputting a set of general activities in which a client may participate.

The My General Activities tab 454 can include a search tool in which a user can enter one or more keywords in a user entry or dialog box 454 for searching for a corresponding activity that is to be added for the client's activity, progress of which can be updated and tracked in the system. A corresponding results box 458 can display relevant search results in response to selecting a search user interface element (a button) 460. If a respective activity is not listed among those available for the client, one can be added manually by activating an Add user interface element 462. Once a given activity is listed it can be highlighted via a pointing device (e.g., a mouse or keyboard) and in turn posted to the general activities log via a post user interface element 466. Associated with each activity that is to be posted, an individual can record the intensity of the activity as well as the duration activity as appropriate. Similar types of information can be entered via a My Stamina Exercises tab element 468 and a My Resistance Training tab element 470.

Depending upon the activity, a corresponding visual indication of progress can be displayed in an adjacent display window 472 over a period of time for the user. For example, the activity progress can be provided in the display window 472 in the form of a graphical display of that includes bar graphs or other types of graphs to demonstrate progress for the client activity over a period of time which can be user selectable. The progress can vary according to the type of activity such as including by displaying the time or other measure for the activity, the number of calories burned for the given activity, which may vary according to the particular activity. An individual can also utilize the GUI 450 to enter or record the progress for a given activity. For example, a user can employ an activity log user interface element 474 to record the quantity or duration of a selected client activity and in turn upload it to the tracking system via a Post user interface element 476. Those skilled in the art will understand that certain types of activities, such as steps can be tracked automatically via a pedometer or other device that can in turn transmit or send corresponding activity information to the tracking system for a given client, such as to automatically populate portions of the activity log. The tracking system can convert the client activity into a measurement data, such as by computing the number of calories burned for a given amount of activity.

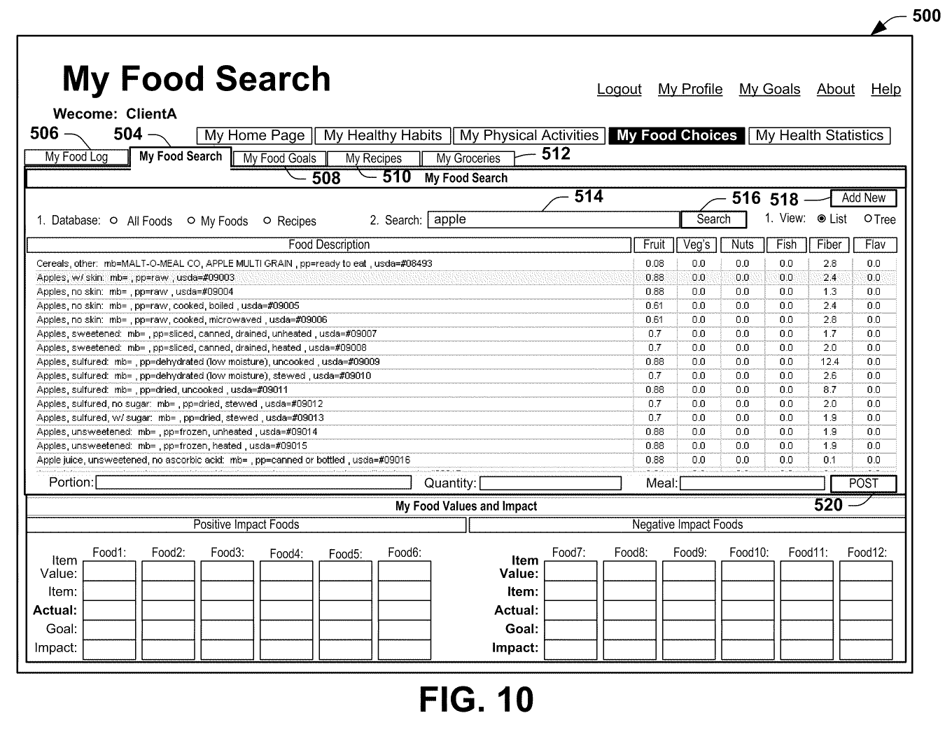

FIG. 10 depicts a page associated with a My Food Choices GUI 500 that can be utilized to provide information about a client's food choices. The GUI 500 can be accessed, for example, by selecting a My Food Choices user interface element 502. By way of example, the My Foods Choices GUI 500 can include a plurality of associated pages for viewing or entering a variety of different types of information that can be accessed by activating or otherwise selecting corresponding tab user interface elements 504, 506, 508, 510 and 512.

In the example of FIG. 10, a My Food Search user interface element 504 has been selected in which a client can in turn search for foods from any number of one or more databases that may be available. Other types of information associated with an individual's food choices that can be accessed the GUI 500 include a food log which can be accessed via a My Food Log user interface tab 506, a My Food Goals user interface tab 508, My Recipes user interface tab 510 and a My Groceries user interface tab 512. Each of these tabs 502-512 can be utilized to record and view additional information about the client's food choices. For instance, the food log can be utilized to log food that the client has consumed. The food can be entered by the client, such as daily or after eating a respective meal. Food goals can be utilized to set goals for the amounts of foods and types of foods that an individual should eat or should avoid during a given day. Recipes can be utilized to provide recipes for the client and my groceries can be utilized to provide a selected type of groceries that an individual should purchase to help facilitate reaching a desired set of food choices. Groceries can also be utilized to generate a list of recommended groceries.

In the example of FIG. 10, the searching for food can performed via a search tool having a user entry field 514 in which a user can identify a food by keyword (e.g., “apple”). After the food name has been entered, a search user interface element 516 can be activated to implement the search. The search results can be displayed in a variety of display types such as in a list (as shown) or a tree. The results of the search can be displayed in a corresponding display such as shown in FIG. 10. Thus, the user can use the search to locate a desired food that has been or is about to be consumed and identify the portion or quantity of the food, what meal it is being consumed at and post this into the food log via a post user interface element 520. Food choices that do not appear can be added into the respective database via an “Add New” user interface element 518.

The my food choices GUI 500 can also provide information associated with food values and the impact on an individual's health such as including a set of positive impact foods as well as a negative impact foods. Thus, sets of foods indicated as foods 1 through 12 can be listed as well as the information about the food such as values, description of the items, the actual amount of servings that have been consumed, a goal for respective food or food type and an impact be it possible or negative for each of the respective foods or food types that are listed in the display in the GUI 500.

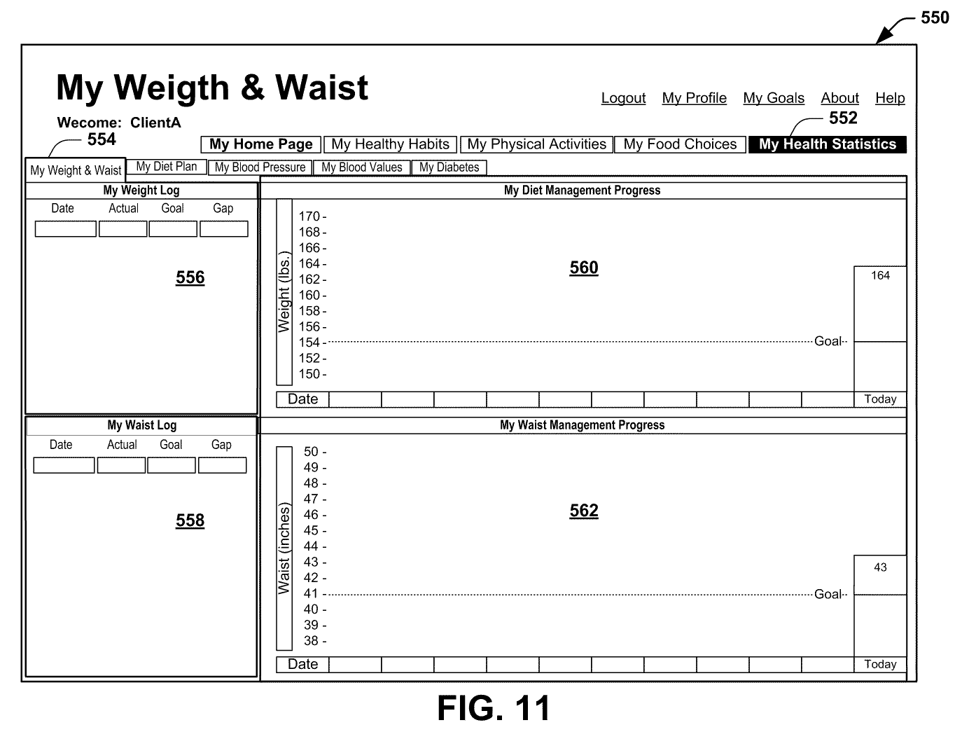

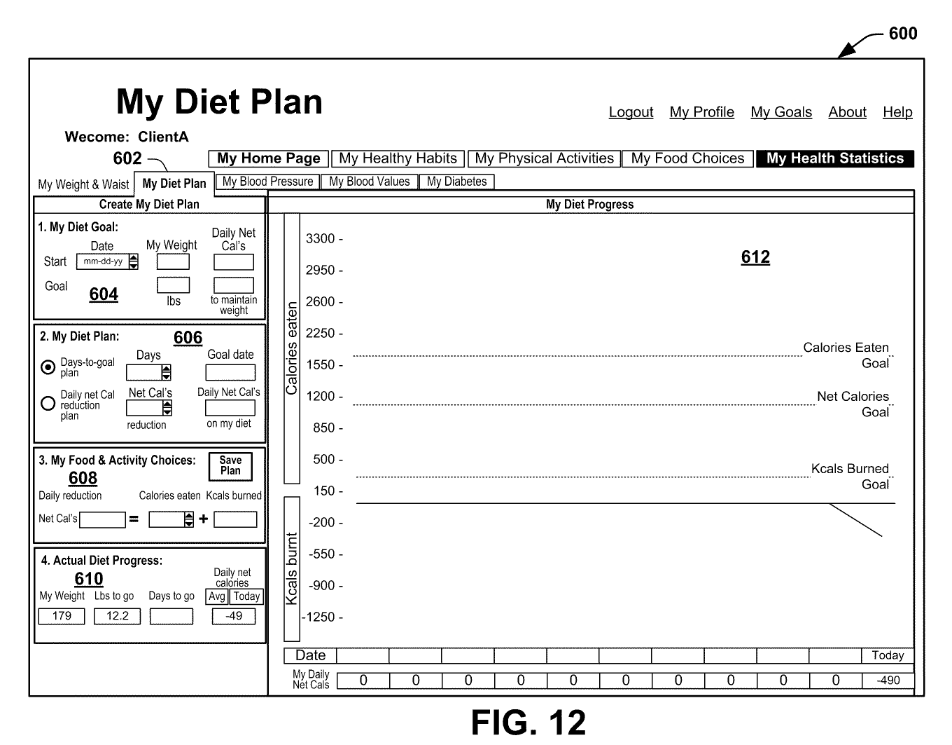

Another component of the tracking system can be health statistics such as described in the summary fashion for the home page GUI 350 of FIG. 7. In my health statistics a set of GUI features can be accessed in a health statistics GUI 550 by selecting the My Health Statistics GUI element 552. The My Health Statistics GUI 550 can include information about a plurality of different types of health conditions and characteristics for a given client, which may vary according to the set of circumstances for each respective client. By way of example, the My Health Statistics GUI 550 can include separate pages or GUI features associated with My Weight & Waist, My Diet Plan, My Blood Pressure, My Blood Value and My Diabetes—each being accessible by a corresponding tab user interface element. Other health conditions can be added according to the needs of a given client. By way of illustration, FIGS. 11 and 12 demonstrate health statistic pages for My Weight & Waist and My Diet Plan.

In the example of FIG. 11, the My Weight & Waist GUI element tab 554 has been selected to provide a corresponding set of features and functions available in the GUI 550. The GUI 550 provides a weight log GUI element (“My Weight Log”) 556 that a user can utilize to log their respective weight for a given day. The individual's weight can be displayed in the log GUI 556 for any number of one or more dates along with the client's weight goal and a gap demonstrating how much weight needs to be lost or gained to achieve their respective goal. As described herein, the goals typically are agreed upon by the client and coach in advance of the individual utilizing the coaching system, such as part of a configuration session.

Depicted in the GUI 550 below the weight log GUI element 556 is a waist log GUI element (“My Waist Log”) 558 that can be utilized in a similar way to display the data and the waist measurement information for the given date as well as the goal of the individual's waist size and the respective gap at the time. Adjacent to each respective GUI element 556 and 558 can be progress displays 560 and 562 showing progress over a desired data range for the client. Each display 560 and 562 can also include a visual representation of a goal to demonstrate the client's progress appears relative to the established goal. In the example of FIG. 11, the goal is set at about 154 pounds, whereas the individual's current weight as of today is about 164 pounds. Similarly, the current goal for the individual's waist is 41 inches whereas the current individual's current waist measurement is 43 inches. These as well other visualizations of progress can be easily visualized on the My Weight and My Waist progress displays 560 and 562 as part of the My Health Statistics GUI 550.

Another example component of the My Health Statistics is a diet plan GUI element (My Diet Plan GUI) 600 such as shown in FIG. 12. The My Diet Plan GUI 600 can be selected via a corresponding tab (or other user interface element) 602 after accessing the My Health Statistics page of the interface. The My Diet Plant GUI 600 can include a plurality of different user interface portions for creating or managing the client's diet plan. For example, the GUI 600 can include a My Diet Goal user interface portion 604, a My Diet Plan user interface portion 606, a My Food & Activity Choices user interface portion 608 and an Actual Diet Progress user interface portion 610. Each of these user interface portions can include interactive features that enable a client to manage and/or visualize the progress for a given aspect of the diet plan.

For example, the My Diet Goal GUI portion 604 can provide information that demonstrates how many calories an individual needs to consume to maintain their current weight or how many calories are needed to maintain their weight for a given weight goal. The My Diet Plan GUI element portion 606 similarly can include an identification of the number of days to achieve their goal on the plan such that the individual can track progress according to one or more different criteria, such as days to go on the plan or the daily net calorie reductions for the plan. The My Food & Activity Choices user interface portion 608 can be utilized to identify net calories for the client as a function of the total calories eaten (e.g., as logged via the My Food Choices GUI) relative to the number of calories burned through activity (e.g., as entered via the My Physical Activities GUI).

Diet progress can also be demonstrated via actual data progress GUI portion 610 to demonstrate the daily net calories for a given day or the average or a given time period. To further visualize the progress for the diet plan, a My Diet Progress graphical portion can be generated by the tracking system, such as indicated at 612. The My Diet Progress display 612 can demonstrate net calories by showing calories eaten, calories burned as well as respective goals for each over a time period.

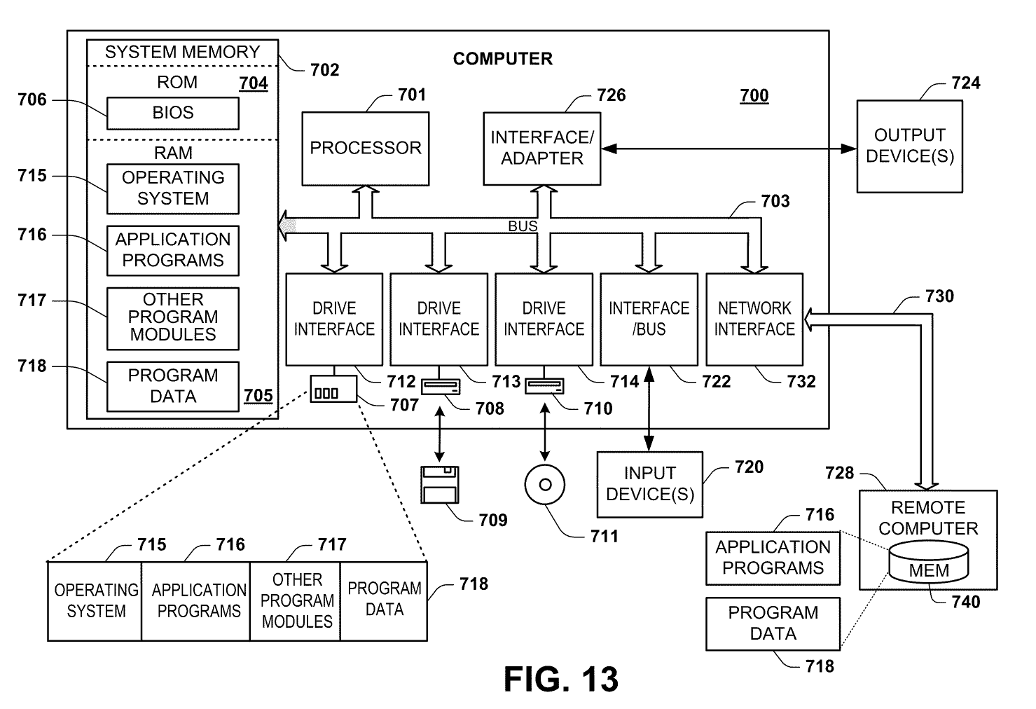

Those skilled in the art will understand and appreciate that a tracking system can obtain detailed information for each client that can be analyzed to generate encouraging responses based on the teachings contained herein. FIG. 13 depicts an example of a “My Blood Pressure” GUI that can be implemented as part of a tracking system for viewing and entering Blood Pressure information according to an aspect of the invention. While not shown, for example, similar types of GUIs can be provided for logging and tracking information relating to the clients blood values (a “My Blood Values” GUI) and other client-specific conditions (e.g., a “My Diabetes” GUI).

In view of the foregoing structural and functional description, those skilled in the art will appreciate that portions of the invention may be embodied as a method, data processing system, or computer program product. Accordingly, these portions of the present invention may take the form of an entirely hardware embodiment, an entirely software embodiment, or an embodiment combining software and hardware, such as shown and described with respect to the computer system of FIG. 13. Furthermore, portions of the invention may be a computer program product on a computer-usable storage medium having computer readable program code on the medium. Any suitable computer-readable medium may be utilized including, but not limited to, static and dynamic storage devices, hard disks, optical storage devices, and magnetic storage devices.

Certain embodiments of the invention have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

In this regard, FIG. 13 illustrates one example of a computer system 700 that can be employed to execute one or more embodiments of the invention by storing and/or executing computer executable instructions. Computer system 700 can be implemented on one or more general purpose networked computer systems, embedded computer systems, routers, switches, server devices, client devices, various intermediate devices/nodes or stand alone computer systems. Additionally, computer system 700 can be implemented on various mobile clients such as, for example, a personal digital assistant (PDA), laptop computer, pager, and the like, provided it includes sufficient processing capabilities.

Computer system 700 includes processing unit 701, system memory 702, and system bus 703 that couples various system components, including the system memory, to processing unit 701. Dual microprocessors and other multi-processor architectures also can be used as processing unit 701. System bus 703 may be any of several types of bus structure including a memory bus or memory controller, a peripheral bus, and a local bus using any of a variety of bus architectures. System memory 702 includes read only memory (ROM) 704 and random access memory (RAM) 705. A basic input/output system (BIOS) 706 can reside in ROM 704 containing the basic routines that help to transfer information among elements within computer system 700.

Computer system 700 can include a hard disk drive 707, magnetic disk drive 708, e.g., to read from or write to removable disk 709, and an optical disk drive 710, e.g., for reading CD-ROM disk 711 or to read from or write to other optical media. Hard disk drive 707, magnetic disk drive 708, and optical disk drive 710 are connected to system bus 703 by a hard disk drive interface 712, a magnetic disk drive interface 713, and an optical drive interface 714, respectively. The drives and their associated computer-readable media provide nonvolatile storage of data, data structures, and computer-executable instructions for computer system 700. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of the present invention.

A number of program modules may be stored in drives and RAM 705, including operating system 715, one or more application programs 716, and other program modules 717, and program data 718. The application programs and program data can include functions and methods programmed to implement rules-based coaching for a given coaching context, such as shown and described herein. For instance, the application programs 716 and other program modules can include instructions executable at a client unit as well as instructions executable at a coaching system, which cooperate to provide automated or semi-automated coaching based on the teachings herein. The program data can store client data and progress data, such as can be received from a given client.

A user may enter commands and other information into computer system 700 through one or more input devices 720, such as a pointing device (e.g., a mouse, touch screen), keyboard, microphone, joystick, game pad, scanner, Bluetooth (or other wireless communications technology) connectable medical or non-medical device, and the like. For instance, the user can employ input device 720 access client data, to update rules or to update a client plan. These and other input devices 720 are often connected to processing unit 701 through a corresponding port interface 722 that is coupled to the system bus, but may be connected by other interfaces, such as a parallel port, serial port, or universal serial bus (USB). One or more output devices 724 (e.g., display, a monitor, printer, projector, or other type of displaying device) is also connected to system bus 703 via interface 726, such as a video adapter.

Computer system 700 may operate in a networked environment using logical connections to one or more remote computers, such as remote computer 728. Remote computer 728 may be a workstation, computer system, router, peer device, or other common network node, and typically includes many or all the elements described relative to computer system 700. The logical connections, schematically indicated at 730, can include a local area network (LAN) and a wide area network (WAN).

When used in a LAN networking environment, computer system 700 can be connected to the local network through a network interface or adapter 732. When used in a WAN networking environment, computer system 700 can include a modem, or can be connected to a communications server on the LAN. The modem, which may be internal or external, can be connected to system bus 703 via an appropriate port interface. In a networked environment, application programs 716 or program data 718 depicted relative to computer system 700, or portions thereof, may be stored in a remote memory storage device 740. Any or all communication(s) to and/or from the computer system and can be implemented via employing secure methods, such as encryption/decryption coding, which may be HIPAA compliant or may be non-HIPAA compliant depending on application requirements.

What have been described above are examples and embodiments of the invention. It is, of course, not possible to describe every conceivable combination of components or methodologies for purposes of describing the invention, but one of ordinary skill in the art will recognize that many further combinations and permutations of the present invention are possible. Accordingly, the invention is intended to embrace all such alterations, modifications and variations that fall within the scope of the appended claims. In the claims, unless otherwise indicated, the article “a” is to refer to “one or more than one.”

What is claimed is:

1. A coaching system, comprising:
a tracking system programmed to receive client data indicative of at least one client condition relevant to a coaching plan designed for a given client;
a rules system programmed to process progress data, which is derived at least in part from the client data, relative to a rule set established for the given client and determine an indication of progress for the given client relative to the coaching plan; and
a response generator that automatically generates a message for the given client, the message having content that varies depending on the indication of progress determined for the given client.

2. The system of claim 1, wherein the automatically generated message comprises a draft message that is sent to a coach for approval before being sent to the given client.

3. The system of claim 2, further comprising:
a messaging system programmed to route the draft message to a predefined address for the coach; and
a coach interface programmed to manage copies of draft messages generated for each of a plurality of different clients, the coach interface including tools programmed to selectively modify the content of the draft message, the coach interface sending the message to the given client responsive to a user input provided by the coach.

4. The system of claim 1, wherein the response generator is programmed to select the message content from a plurality of predefined messages.

5. The system of claim 4, wherein the client data further comprises profile data identifying at least one personality characteristic of the given client, wherein the response generator is programmed to select the message content for the given client based on the profile data.

6. The system of claim 5, wherein the plurality of predefined messages is stored in memory as response data, the response data having associated metadata classifying each of the plurality of predefined messages according to personality characteristics of intended recipients, the response generator selecting the message for the given client based on the profile data.

7. The system of claim 1, further comprising a client unit associated with the given client, the client unit being programmed to send a client message to the tracking system that includes the client data for the given client.

8. The system of claim 7, further comprising a template generator programmed to generate at least one template for the given client according to the coaching plan for the given client, the at least one template being employed at the client unit to facilitate receiving the client data.

9. The system of claim 7, wherein the tracking system further comprising a data extractor programmed to extract the client data from the client message sent from the client unit.

10. The system of claim 1, wherein the rules system further comprises a rules engine programmed to apply the rule set to the progress data to ascertain the indication of progress for the given client.

11. The system of claim 1, wherein the rule set for the given client is programmed according to a defined coaching context consistent with the coaching plan, wherein the defined coaching context comprises at least one of wellness coaching, business coaching, personal coaching, finance coaching, and relationship coaching.

12. The system of claim 11, wherein at least a portion of the rules in the rule set are devised by an expert or an expert panel for the defined coaching context.

13. The system of claim 12, wherein the at least a portion of the rules in the rule set are devised based on evidence data.

14. The system of claim 11, wherein the rule set is programmable.

15. The system of claim 14, wherein the rule set is modified automatically according to the progress data for the given client relative to the coaching plan.

16. The system of claim 14, wherein the rule set is modified in response to information associated with the given client that is entered into the system electronically by at least one of a client monitoring device, a coach or an expert.

17. The system of claim 14, wherein the rule set is modified consistently with rules utilized by other clients successfully to achieve at least one goal in the same defined coaching context as the given client.

18. The system of claim 1, further comprising a manager programmed to configure a client profile for the given client.

19. The system of claim 1, wherein the content of the message comprises information that is positive and motivational for the given client to facilitate reaching one or more goals defined by the coaching plan.

20. The system of claim 1, wherein the client data includes data identifying the given client and profile data identifying at least one personality attribute of the given client, wherein the response generator selects the message for the given client from a plurality of available messages according to the at least one personality attribute.

21. The system of claim 1, further comprising a program generator programmed to generate plan data for the coaching plan, the plan data defining a set of goals for the given client over a period of time, the rules system analyzing the progress data relative to the set of goals to determine the indication of progress for the given client.

22. The system of claim 1, wherein the coaching plan comprises a series of goals agreed to by the given client and at least one coach assigned to the given client.

23. The system of claim 1, wherein at least a portion of the client data includes data associated with a condition of the given client that is provided to the tracking system by at least one of an electronic notification system and a portable electronic device.

24. The system of claim 23, wherein at least a portion of the client data includes health-related information for the given client that is provided to the tracking system by a monitoring device configured to monitor and detect at least one physical condition of the given client.

25. The system of claim 24, wherein the monitoring device comprises at least one of a Bluetooth-enabled pedometer, or blood pressure cuff, or sleep monitoring device, a blood monitoring device, and a heart rate monitor.

26. The system of claim 1, wherein the message for the given client further comprises status data that is sent from the response generator to at least one of an electronic notification system, a portable electronic device and an electronic medical record database.

27. The system of claim 1, wherein the response generator is programmed to select the message content from a plurality of predefined messages corresponding to a subset of messages preselected for the given client, wherein the subset of messages preselected for the given client is modified based on at least one of client risk factors, client mental status, situation, disease entity.

28. The system of claim 1, wherein subset of messages preselected for the given client is modified based on the indication of progress for the given client.

29. The system of claim 1, wherein subset of messages preselected for the given client is modified based on identifying messages utilized to achieve successful outcomes for other similarly classified clients.

30. The system of claim 1, further comprising a security module to transmit information securely within the coaching system.

31. The system of claim 1, further comprising a notification system programmed to notify a pre-identified individual if the progress data is outside expected parameters.

32. The system of claim 1, wherein the given client comprises a multitudinous of respective clients, each being assigned to a common coach.

33. An automated coaching system, comprising:
a tracking system programmed to receive client data indicative of at least one client condition relevant to a coaching plan designed for a given client;
a rules system programmed to process progress data, which is derived at least in part from the client data, relative to a rule set established for the given client and determine an indication of progress for the given client relative to the coaching plan;
profile data identifying at least one characteristic of the given client;
a response generator that automatically generates a message for the given client, the message having content that varies depending on the indication of progress determined for the given client, the response generator selecting the message from a subset of messages preselected for the given client from a plurality of predefined messages based on the profile data; and
a coaching user interface programmed to enable a coach to at least one of approve and selectively modify the content of the message that has been generated for the given client.

34. The coaching system of claim 33, wherein the at least one characteristic of the given client comprises at least one of a personality or psychological characteristic of the given patient.
